(19) United States
(12) Patent Application Publication
(10) Pub. No.: US 2004/0165258 A1
(43) Pub. Date: Aug. 26, 2004

(54) Stereoscopic microscope, and an observation mechanism for use in a stereoscopic microscope

(75) Inventor: Tomoaki Yamashita, Hachioji-shi (JP)

Correspondence Address: OSTROLENK FABER GERB & SOFFEN, 1180 AVENUE OF THE AMERICAS, NEW YORK, NY, 100368403

(73) Assignee: Olympus Corporation

(21) Appl. No.: 10/756,681

(22) Filed: Jan. 13, 2004

(30) Foreign Application Priority Data
Jan. 15, 2003 (JP) 2003-007215

(51) Int. Cl. G02B 21/22

(52) U.S. Cl. 359/378; 359/368

(57) ABSTRACT

A stereoscopic microscope includes an objective optical system by which a portion to be observed is observed, a lens body which holds the objective optical system, an optical splitter which is disposed in the lens body to divide a luminous flux passed through the objective optical system into at least two, an image forming device which is disposed on at least one optical path of the luminous fluxes divided by the optical splitter to form an observation image by the luminous fluxes, and a support section which opens at least a part of the optical path of the luminous flux to the image forming device from the optical splitter to the outside of the lens body to hold the image forming device.

### CROSS-REFERENCE TO RELATED APPLICATIONS

This application is based upon and claims the benefit of priority from the prior Japanese Patent Application No. 2003-007215, filed Jan. 15, 2003, the entire contents of which are incorporated herein by reference.

### BACKGROUND OF THE INVENTION

1. Field of the Invention

The present invention relates to a stereoscopic microscope for use in a surgical operation or diagnosis of a micro affected part, for example, in departments of neurosurgery, otolaryngology, orthopedic surgery, plastic surgery, obstetrics and gynecology, and ophthalmology.

2. Description of the Related Art

Heretofore, a microscope for a surgical operation for enlarging/observing a part to be operated on in a stereoscopic manner has been used to securely perform a finer surgical operation in departments of neurosurgery and the like. In general, a microscope for a surgical operation includes main observation means for observing a part to be operated on by a main surgeon who carries out the surgical operation, and sub-observation means for an assistant who assists the surgeon.

Positions of the main and sub-observation means need to be freely changed in accordance with a mode of the surgical operation (technique). Especially, the position of the sub-observation means needs to be frequently changed in accordance with the movement of the main observation means by the main surgeon.

In consideration of the above-described situations, a microscope for a surgical operation has been considered including various mechanisms for changing the position of the sub-observation means. Conventional microscopes for surgical operations will hereinafter be described.

(1) Operating Microscope to Which Sub-Observation Means is Detachably Attached

This operating microscope includes a lens body including an objective optical system, main and sub-observation means connected to the lens body, and an intermediate lens tube connecting the sub-observation means to the lens body. The intermediate lens tube is detachably attached to the lens body, and is constituted in such a manner that an attached position with respect to the lens body can be changed. When the attached position of the intermediate lens tube is changed, an observation position of the sub-observation means is changed.

(2) Operating Microscope Described in Jpn. Pat. Appln. KOKAI Publication No. 5-27182

The operating microscope includes an optical observation system by which stereoscopic viewing by an observer is possible as main and sub-observation means. The operating microscope also includes the lens body and intermediate lens tube in the same manner as in the operating microscope of (1). It is to be noted that the intermediate lens tube is connected to the lens body so as to be rotatable centering on an optical axis of the objective optical system. Therefore, the observation position of the sub-observation means can be changed without detachably attaching the sub-observation means with respect to the lens body.

(3) Operating Microscope Described in Jpn. Pat. No. 3032214 (See Patent Document 2)

This operating microscope includes an objective optical system, image pickup means including a light receiving surface in an image forming position of a member to be observed by the objective optical system, a lens body which holds the objective optical system and image pickup means, and observation means for displaying an image picked up by the image pickup means. The observation means includes a monitor on which the image is to be displayed, and an eyepiece section, and the picked-up image can be observed via the eyepiece section (hereinafter referred to as an electronic finder system).

This observation means is disposed independently of the lens body, and is fixed to a user's head so as to be movable in a three-dimensional direction. For example, the observation means has a shape like eyeglasses. Therefore, the observation means can freely move regardless of the position of the lens body. Therefore, the observation means can be used in the sub-observation means for frequently changing the observation position.

(4) Operating Microscope Described in Jpn. Pat. Appln. KOKAI Publication No. 2001-145640 (See Patent Document 3)

In addition to the constituting elements of the operating microscope of the above (3), this operating microscope includes position detection means for detecting the position of the observation means, and image rotation means for rotating the picked-up image. Therefore, for the operating microscope, the picked-up image can be rotated in accordance with the position of the observation means. Therefore, this operating microscope can alleviate an observer's fatigue.

(5) Operating Microscope Including Observation Means of Monitor System

The operating microscope includes observation means of the monitor system in accordance with another related art of the electronic image finder system. The observation means of the monitor system includes a monitor in which two images photographed by the image pick-up means and having a parallax are alternately displayed, and eyeglasses having a left/right successive switch shutter function synchronized with an image switch period of the monitor. An observer wears the eyeglasses to observe the images which are successively displayed on the monitor in the same position and which have the parallax, so that an observation portion can stereoscopically be observed. It is to be noted that the observer can freely change the observation position regardless of the position of the lens body even in the operating microscope.

The main surgeon and assistant sometimes directly view the observation portion in addition to the observation of the part to be operated by use of the observation means in the above-described surgical operation using the above-described operating microscope.

Therefore, there's a need for a stereoscopic microscope by which observation by direct viewing can easily be performed in addition to observation of an observation portion via an objective optical system.

### BRIEF SUMMARY OF THE INVENTION

According to one aspect of the present invention, there is provided a stereoscopic microscope comprising:

an optical objective lens for observation, transmitting luminous fluxes from objects;

an optical splitter to divide the luminous flux transmitted through the optical objective lens into at least two;

a lens body which holds the optical objective lens and the optical splitter;

an image forming device which is disposed on at least one optical path of the luminous fluxes divided by the optical splitter to form an observation image by the luminous fluxes; and

a support member for the image forming device which stride over at least a part of the optical path exposed to the outside of the lens body.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a whole diagram of a operating microscope according to a first embodiment;

FIG. 2 is a schematic diagram showing an optical system of a microscope section shown in FIG. 1;

FIG. 3 is a front view showing the microscope section of a second embodiment;

FIG. 4 is a schematic diagram showing the optical system of the microscope section shown in FIG. 3;

FIG. 5 is a front view showing the microscope section of a third embodiment;

FIG. 6 is a schematic diagram showing the optical system of the microscope section in FIG. 5;

FIG. 7 is a schematic diagram showing the optical system of an image projection device in FIG. 6; and

FIG. 8 is a schematic diagram showing a support member in FIG. 5.

### DETAILED DESCRIPTION OF THE INVENTION

Embodiments of the present invention will hereinafter be described with reference to the drawings.

### FIRST EMBODIMENT

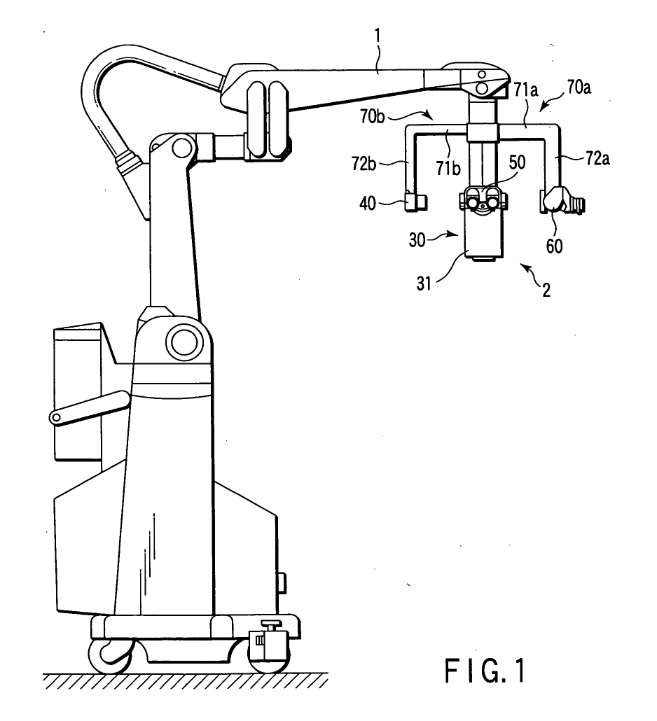

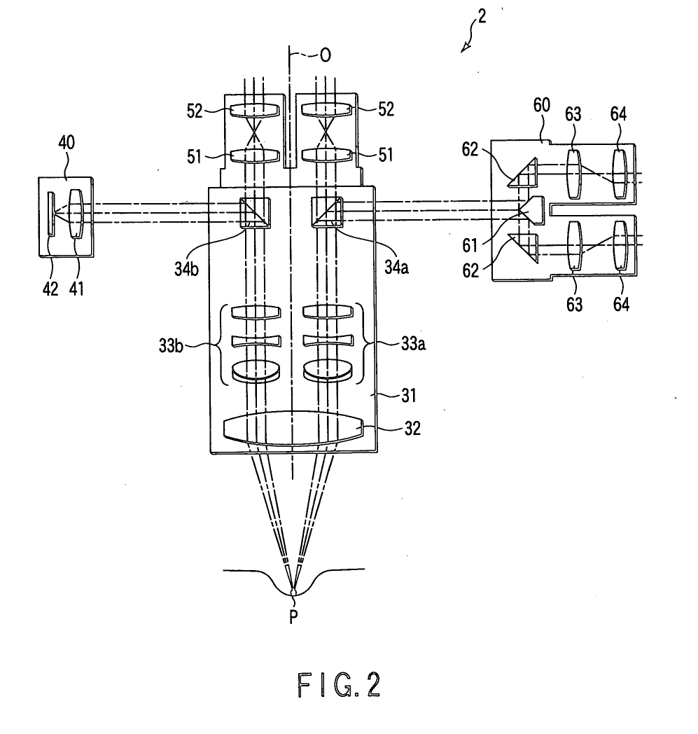

First, a operating microscope of a first embodiment will be described with reference to FIGS. 1 and 2. FIG. 1 is a whole diagram of the operating microscope according to the present embodiment. FIG. 2 is a schematic diagram showing an optical system of a microscope section shown in FIG. 1.

As shown in FIG. 1, a operating microscope of the present embodiment includes a base 1 and a microscope section 2. The base 1 holds the microscope section 2 in an end, and is constituted in such a manner that the microscope section 2 can three-dimensionally be moved. The base 1 is constituted in such a manner that the microscope section 2 can stand still in an optional position.

The microscope section 2 includes a microscope section main body 30, a television camera 40, a main finder 50, a sub-finder 60, and two support members 70a, 70b.

The microscope section main body 30 is movably connected to the base 1 and includes a known constitution for observation of an observation portion P which is an observation object. The microscope section main body 30 guides luminous fluxes from the observation portion P to the television camera 40, main finder 50, and sub-finder 60 which are observation means.

[Constraction]

An optical system of the microscope section main body 30 will hereinafter be described with reference to FIG. 2. As shown in FIG. 2, the microscope section main body 30 includes a lens body or housing 31, an objective lens 32, a pair of variable power optical systems 33a, 33b, and a pair of beam splitters 34a, 34b. It is to be noted that as shown in FIG. 2, the objective lens 32, variable power optical systems 33a, 33b, and beam splitters 34a, 34b are arranged in the lens body 31, and are arranged along an optical axis O of the objective lens 32 in order from an observation portion P side.

The objective lens 32 is a known objective optical system, and the luminous flux from the observation portion P is incident upon each of the pair of variable power optical systems 33a, 33b.

For the variable power optical systems 33a, 33b, a magnification of an observation image from the objective lens 32 is changed to an optional magnification, and the image is incident upon the corresponding beam splitters 34a, 34b as parallel light beams.

Each of the beam splitters 34a, 34b is optical path division means for dividing the optical path of the luminous flux from the corresponding variable power optical systems 33a, 33b into two. Concretely, the beam splitters 34a, 34b transmit a part of the luminous flux from the corresponding variable power optical systems 33a, 33b in a direction along the optical axis O of the objective lens 32, and reflect the remaining part of the luminous flux in a direction which intersects with the optical axis O.

The television camera 40 is a photography device which photographs the observation portion P observed by the microscope section main body 30. As shown in FIG. 2, the television camera 40 includes an image forming lens 41 and an image pick-up device 42. The image pick-up device 42 which is an image pick-up means is disposed on an image forming point by the image forming lens 41. The image pick-up device 42 electrically forms the observation image by an optical image formed by the image forming lens 41. In this manner, the television camera 40 forms the observation image which can be observed by an observer by the image pick-up device 42. It is to be noted that in the present description, the device and means for forming the image which can be observed by the observer will be referred to as image forming means. Therefore, the television camera 40 is the image forming means.

Moreover, the image pick-up device 42 is connected to a camera control unit (CCU) (not shown). The CCU converts an output result of the image pick-up device 42 into an image signal. Furthermore, the CCU is connected to an image storage device (not shown) for storing the image.

The main finder 50 is main observation means for observing the observation portion P via the microscope section main body 30 by a main surgeon who carries out a surgical operation. As shown in FIG. 2, the main finder 50 includes a pair of left/right image forming lenses 51 and a pair of eyepiece lenses 52 corresponding to one pair of image forming lenses 51. One pair of image forming lenses 51 are disposed on the optical path of the luminous flux transmitted through the beam splitters 34a, 34b.

The sub-finder 60 is sub-observation means for an assistant who assists the surgical operation to observe the observation portion P via the microscope section main body 30. The sub-finder 60 includes a pupil division prism 61, a pair of prisms 62, a pair of image forming lenses 63, and a pair of left/right eyepiece lenses 64.

The pupil division prism 61 divides the incident luminous flux into two, so that the luminous fluxes are incident upon the pair of left/right prisms 62. The luminous fluxes incident upon the prisms are formed into an observation image by the image forming lenses 63, and are incident upon the eyepiece lenses 64. The observer can observe the image formed by the image forming lenses 63 via the eyepiece lenses 64. The sub-finder 60 is also image forming means for providing the observation image to the observer in this manner.

One end of each of two support members 70a, 70b is connected to the base 1. The support member 70a supports the television camera 40 outside the lens body 31 in the other end, and the support member 70b supports the sub-finder 60 outside the lens body 31 in the other end. That is, the support members 70a, 70b are support member for supporting the image forming means.

Concretely, the support member 70a supports the sub-finder 60 in such a manner that the pupil division prism 61 is disposed on the optical path of the luminous flux reflected by the beam splitter 34a. The support member 70b supports the television camera 40 in such a manner that the image forming lens 41 is disposed on the optical path of the luminous flux reflected by the beam splitter 34b.

Moreover, the support members 70a, 70b are constituted in the support so as to expose the optical path of the luminous flux from the microscope section main body 30 to the outside of the lens body 31. In other words, in the support of the television camera 40 or the sub-finder 60, each of the support members 70a, 70b is constituted in such a manner that the member does not intersect with the optical path of the luminous flux from the microscope section main body 30 or the whole luminous flux is not covered. Furthermore, in other words, the support members 70a, 70b support the television camera 40 and sub-finder 60 so as to open the optical path to the outside of the lens body 31. Therefore, when the observer directly observes the observation portion P in the vicinity of the television camera 40 and sub-finder 60, a space capable of passing an observer's line of vision to the observation portion P spreads in at least a part on the optical path.

Concretely, as shown in FIG. 1, the support members 70a, 70b have V shapes including parallel sections 71a, 71b extending in parallel with the optical paths of the luminous fluxes from the beam splitters 34a, 34b, and orthogonal sections 72a, 72b which extend in a direction crossing at right angles to the corresponding parallel sections 71a, 71b. One end of each of the orthogonal sections 72a, 72b is connected to the base 1, and the other end thereof is connected to one end of the corresponding orthogonal section 72a or 72b. The other end of the orthogonal section 72a or 72b supports the television camera 40 or the sub-finder 60. Therefore, as shown in FIG. 1, a region extending along the optical path between the television camera 40 or the sub-finder 60 and the lens body 31 is completely exposed to the outside of the lens body 31.

Moreover, the operating microscope includes an illuminating optical system (not shown).

[Function/Effect]

An operation and effect of the operating microscope constituted as described above will hereinafter be described.

First, a case where the main surgeon and assistant observe the observation portion P via the microscope section main body 30 will hereinafter be described.

To observe the observation portion P, the surgeon first moves the microscope section main body 30 to a position where the observation portion P can be observed. It is to be noted that the microscope section main body 30 is three-dimensionally movably supported by the base 1, and can therefore be moved to the optional position.

The luminous flux from the observation portion P is incident upon the objective lens 32, passed through the pair of variable power optical systems 33a, 33b, and divided into two optical paths by the beam splitters 34a, 34b as described above.

The luminous flux passed through the beam splitters 34a, 34b is incident upon the main finder 50. The luminous flux passed through the beam splitters 34a, 34b is passed through the corresponding image forming lens 51, and is incident upon the eyepiece lens 52. The main surgeon can stereoscopically observe the observation portion P via one pair of left/right eyepiece lenses 52.

The luminous flux reflected by the beam splitters 34a, 34b, that is, the luminous flux traveling in a direction crossing at right angles to the optical axis O of the objective lens 32 goes out of the lens body 31, and is incident upon the television camera 40 or the sub-finder 60.

The luminous flux incident upon the television camera 40 is transmitted through the image forming lens 41 and formed into the image on the image pick-up device 42. The image pick-up device 42 picks up the observation image, and sends and stores the picked-up image into the image storage device via the CCU. Therefore, the television camera 40 is capable of recording the observation image of the observation portion P.

The luminous flux incident upon the sub-finder 60 is divided by the pupil division prism 61. The assistant can observe the divided luminous fluxes via the prisms 62, image forming lenses 63, and eyepiece lenses 64.

Subsequently, a case where the main surgeon and assistant directly view the observation portion P not via the microscope section main body 30 will be described.

For the direct viewing, the main surgeon and assistant divert their lines of vision from the main and sub-finders 50, 60 toward the observation portion P. As shown in the constitution, an opened space connected to the outside of the lens body 31 spreads between the television camera 40 or the sub-finder 60 and the lens body 31 in the region along the optical path of the luminous flux reflected by the beam splitters 34a, 34b. That is, the operating microscope of the present embodiment does not include an intermediate lens tube connecting the lens body 31 to the sub-finder 60 which is the sub-observation means. Therefore, the surgeon and assistant can directly view the observation portion P in such a manner that the lines of vision pass through the space. That is, the surgeon and assistant can directly view the observation portion P so as to avoid the intermediate lens tube without largely moving the head. Therefore, by the operating microscope of the present embodiment, the observation by the direct viewing can easily be performed in addition to the observation of the observation portion via the objective optical system.

Moreover, in the operating microscope of the present embodiment, different from an electronic image finder system described above in the related art, the observation means attached to the main surgeon assistant heads are not used. Therefore, the observation of the observation portion via the objective optical system and the observation by the direct viewing can easily be changed over.

Furthermore, for the operating microscope of the present embodiment, the observation mechanism (the television camera 40 and sub-finder 60) is combined with the microscope section main body 30 including the known constitution by the support members 70a, 70b constituted as described above. Therefore, the operating microscope of the present embodiment can be constituted by incorporating the conventional general stereoscopic microscope as the microscope section main body 30, and can therefore inexpensively be embodied.

### SECOND EMBODIMENT

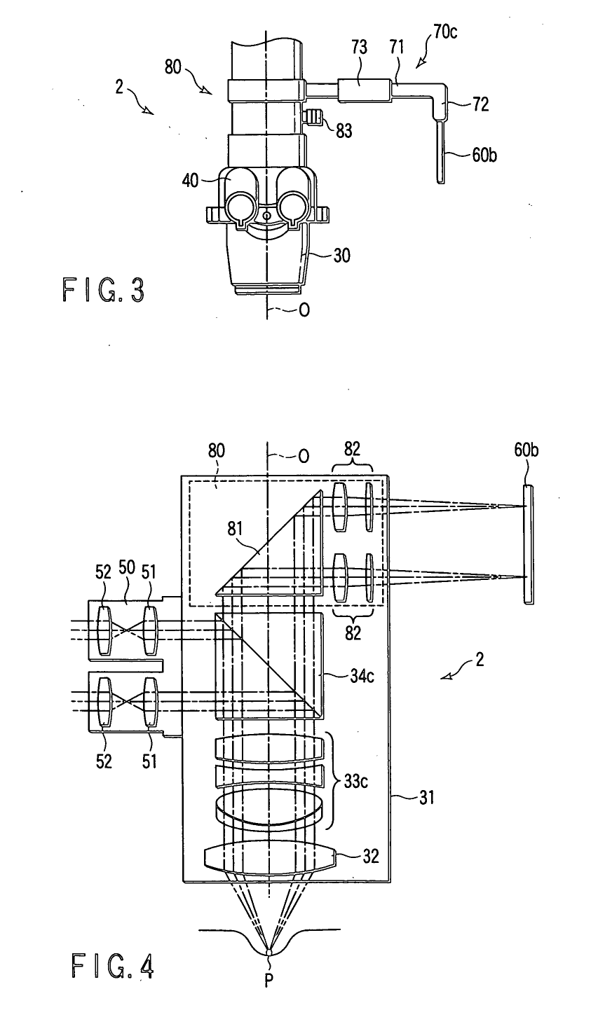

The operating microscope according to a second embodiment of the present invention will hereinafter be described with reference to FIGS. 3 and 4. It is to be noted that in the present embodiment, the constituting members similar to those of the operating microscope of the first embodiment are denoted with the same reference numerals as those of the operating microscope of the first embodiment, and detailed description is omitted.

[Constitution]

FIG. 3 is a front view of the microscope section 2 of the present embodiment. FIG. 4 is a schematic diagram showing the optical system of the microscope section 2 in FIG. 3. The microscope section 2 of the operating microscope of the present embodiment is different from that of the first embodiment. The microscope section 2 of the present embodiment will hereinafter be described.

As shown in FIG. 3, the microscope section 2 of the present embodiment includes the microscope section main body 30, the main finder 50, a transmission type Fresnel lens 60b, and a support member 70c.

As shown in FIG. 4, the microscope section main body 30 includes the lens body 31, the optical objective lens 32, a variable power optical system 33c, a beam splitter 34c, and one stereoscopic image projection means 80. The objective lens 32, variable power optical system 33c, beam splitter 34c, and stereoscopic image projection means 80 are arranged in the lens body 31, and are arranged along the optical axis O of the objective lens 32 in order from a side disposed opposite to the observation portion P.

By the objective lens 32, the luminous flux from the observation portion P is incident upon the variable power optical system 33c.

For the variable power optical system 33c, the magnification of the observation image from the objective lens 32 is changed to the optional magnification, and the image is incident upon the corresponding beam splitter 34c as the parallel lights.

The beam splitter 34c is the optical path division means for dividing the optical path of the luminous flux from the variable power optical system 33c into two. Concretely, the beam splitter 34c which is an optical splitter transmits a part of the luminous flux from the variable power optical system 33c in the direction along the optical axis O of the objective lens 32, and reflects the remaining luminous flux in the direction which intersects with the optical axis O.

The stereoscopic image projection means 80 is an image projection device which projects a stereoscopic observation image onto a transmission type Fresnel lens 60b. The stereoscopic image projection means 80 is rotatably constituted centering on the optical axis O of the objective lens 32. The stereoscopic image projection means 80 includes a prism 81 and a pair of optical image forming systems 82.

The prism 81 reflects the luminous flux transmitted through the beam splitter 34c in a direction intersecting the optical axis O.

One pair of optical image forming lenses 82 is an optical image forming system in which the image forming position can be changed by a focus adjustment knob 83 shown in FIG. 3. It is to be noted that one pair of optical image forming systems 82 are connected to the focus adjustment knob 83 by a link (not shown). The pair of optical image forming systems 82 are arranged on the optical paths of the luminous fluxes reflected by the prism 81.

The main finder 50 includes one pair of left/right image forming lenses 51 and eyepiece lenses 52. The image forming lenses 51 are disposed on the optical paths of the luminous fluxes reflected by the beam splitter 34c.

The transmission type Fresnel lens 60b is the sub-observation means for the assistant to stereoscopically observe the operation part. That is, the transmission type Fresnel lens 60b is the image forming means. The transmission type Fresnel lens 60b which is an image forming device is disposed on the optical of the luminous flux transmitted through one pair of optical image forming systems 82.

One end of the support member 70c is connected to the stereoscopic image projection means 80, and the other end thereof supports the transmission type Fresnel lens 60b outside the lens body 31. By this support, the transmission type Fresnel lens 60b is disposed on the optical paths of the optical image forming systems 82. It is to be noted that in the same manner as in the first embodiment, the support member 70c completely exposes the region along the optical path between the transmission type Fresnel lens 60b which is the observation means and the lens body 31 to the outside of the lens body 31.

Moreover, since one end of the support member 70c is connected to the stereoscopic image projection means 80 as described above, the member rotates with the rotation of the stereoscopic image projection means 80 around the optical axis O of the objective lens 32.

Furthermore, in the same manner as in the first embodiment, the support member 70c includes a parallel section 71 and an orthogonal section 72. It is to be noted that the parallel section 71 of the present embodiment includes a stretching portion 73 stretchable along a longitudinal direction of the section.

[Function/Effect]

The operation and effect of the operating microscope constituted as described above will hereinafter be described.

The luminous flux from the observation portion P is incident upon the objective lens 32, passed through the variable power optical system 33c, and divided into two optical paths by the beam splitter 34c as described above.

The luminous flux reflected by the beam splitter 34c is incident upon the main finder 50. The main surgeon can stereoscopically observe the observation portion P via the main finder 50.

Moreover, the luminous flux transmitted through the beam splitter 34c is projected on the transmission type Fresnel lens 60b by the stereoscopic image projection means 80.

Concretely, the luminous flux transmitted through the beam splitter 34c is reflected in a direction intersecting with the optical axis O of the objective lens 32 by the prism 81. The reflected luminous flux is incident upon one pair of optical image forming systems 82, and projected on the transmission type Fresnel lens 60b disposed outside the lens body 31.

Moreover, when the image forming position of the optical image forming systems 82 is adjusted by the focus adjustment knob 83, the observation image is formed on the transmission type Fresnel lens 60b.

The assistant can stereoscopically observe the observation portion P via the transmission type Fresnel lens 60b.

Next, a case where the transmission type Fresnel lens 60b is rotated around the optical axis O will be described.

When the transmission type Fresnel lens 60b is rotated around the optical axis O, the stereoscopic image projection means 80 simultaneously rotate in the same direction. Therefore, the assistant stereoscopically observes the observation image of the operating microscope in the same manner as in a case where the means is not rotated.

Next, a case where the transmission type Fresnel lens 60b is moved along the longitudinal direction of the parallel section 71 of the support member 70c will be described.

The support member 70c moves the transmission type Fresnel lens 60b along the longitudinal direction by expansion and contraction of the stretching portion 73. When the transmission type Fresnel lens 60b is moved in this manner, the assistant adjusts the focus adjustment knob 83 to operate the optical image forming systems 82 so that the image forming position agrees with the transmission type Fresnel lens 60b. Even when the stretching portion 73 expands/contracts in this case, the assistant can stereoscopically observe the observation image.

Moreover, the surgeon and assistant use the space exposed to the outside between the lens body 31 and the transmission type Fresnel lens 60b which is the sub-observation means in the same manner as in the first embodiment, and can directly view the operation part. In this manner, by the operating microscope of the present embodiment, in addition to the observation of the observation portion via the objective optical system, the observation by the direct viewing can easily be carried out in the same manner as in the first embodiment.

Moreover, since the operating microscope of the present embodiment uses the transmission type Fresnel lens 60b as the sub-observation means, a complicated optical system is not required in the sub-finder, and the sub-finder can be constituted in a light weight. Therefore, for the operating microscope of the present embodiment, there can be provided a sub-finder whose influence of a weight balance onto the lens body is small and which is satisfactory in operability.

Furthermore, the transmission type Fresnel lens 60b has a large emission pupil. Therefore, even when the observer slightly shifts an observation position, the observation image can be observed. Therefore, the assistant freely selects a standing position during the surgical operation, and can easily carry out the operation.

Additionally, the support member 70c rotates around the optical axis O of the objective lens 32 together with the stereoscopic image projection means 80. Therefore, even when the support member 70c is rotated, the observation image can constantly be projected onto the transmission type Fresnel lens 60b. Since the transmission type Fresnel lens 60b can rotate around the optical axis O in this manner, the assistant can freely change the observation position, and can easily carry out the operation.

Moreover, the stereoscopic image projection means 80 rotates around the optical axis O in accordance with the rotation of the support member 70c as described above. Therefore, the observation image projected on the transmission type Fresnel lens 60b rotates around the optical axis O in synchronization with the rotation of the stereoscopic image projection means 80. That is, the observation image rotates with the same rotation amount as that around the optical axis O of the transmission type Fresnel lens 60b. Therefore, for the operating microscope of the present embodiment, even when the transmission type Fresnel lens 60b rotates around the optical axis O, the observer's observation position can be matched with the direction of the observation image even with the simple constitution. That is, the operating microscope of the present embodiment can alleviate the observer's fatigue.

Furthermore, since the support member 70c of the present embodiment can expand/contract along the longitudinal direction of the parallel section 71, an interval between the lens body 31 and the transmission type Fresnel lens 60b can optionally be selected. Therefore, the interval can optionally be set to such an extent that the surgeon and assistant can easily directly view the observation portion P.

### THIRD EMBODIMENT

The operating microscope according to a third embodiment of the present invention will hereinafter be described with reference to FIGS. 5 to 8. It is to be noted that in the present embodiment, the constituting members similar to those of the operating microscope of the first or second embodiment are denoted with the same reference numerals as those of the operating microscope of the first or second embodiment, and the detailed description is omitted.

[Constitution]

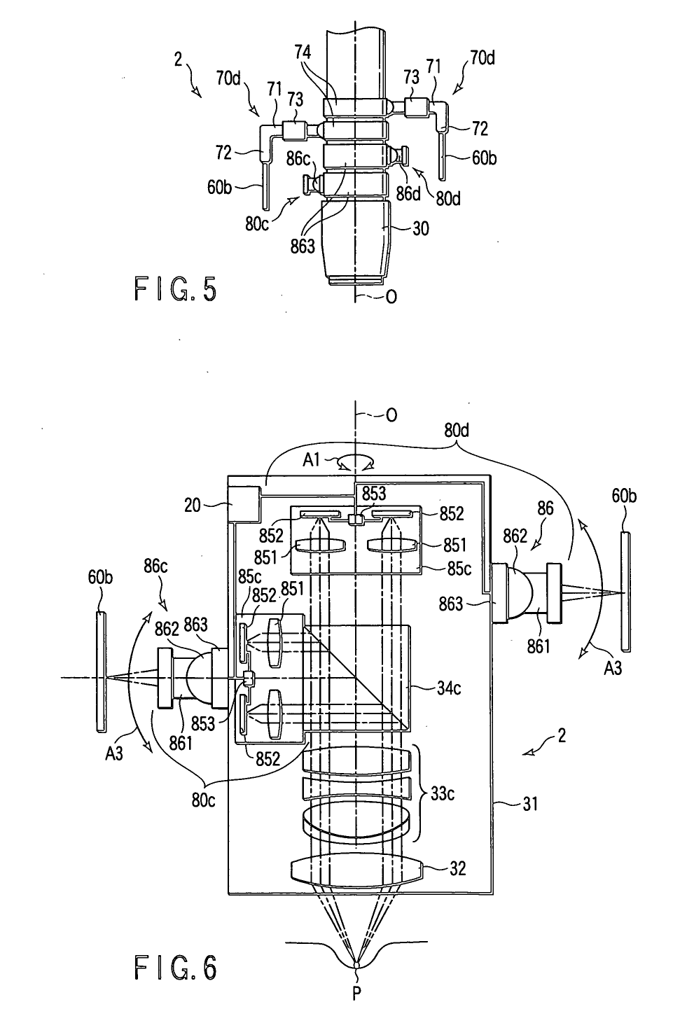

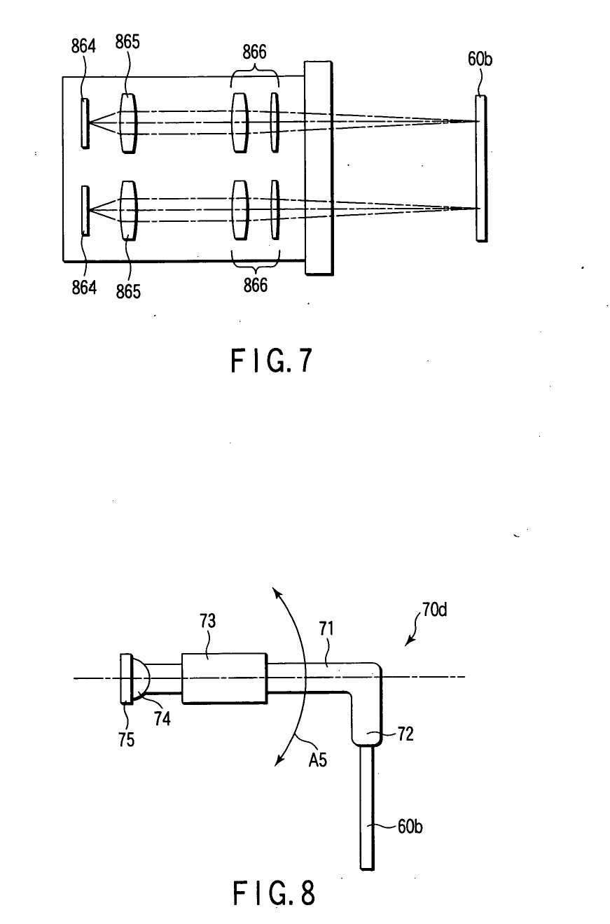

FIG. 5 is a front view of the microscope section 2 of the present embodiment. FIG. 6 is a schematic diagram showing the optical system of the microscope section 2 in FIG. 5. FIG. 7 is a schematic diagram showing the optical system of an image projection device in FIG. 6. FIG. 8 is a schematic diagram showing the support members in FIG. 5.

As shown in FIG. 5, the microscope section 2 of the present embodiment includes the microscope section main body 30, two transmission type Fresnel lenses 60b, and two support members 70d.

As shown in FIG. 6, the microscope section main body 30 includes the lens body 31, objective lens 32, variable power optical system 33c, and beam splitter 34c in the same manner as in the second embodiment. The microscope section main body 30 of the present embodiment further includes electronic stereoscopic image projection means 80c, 80d for projecting the image on the transmission type Fresnel lens 60b.

The electronic stereoscopic image projection means 80c, 80d which are electronic image projection means include similar constitutions. Concretely, the electronic stereoscopic image projection means 80c includes an image pick-up section 85c and a projection section 86c. The electronic image projection means 80d includes an image pick-up section 85d and projection section 86d constituted in the same manner as in the electronic stereoscopic image projection means 80c.

The image pick-up sections 85c, 85d are arranged in the lens body 31. Concretely, the image pick-up section 85c is disposed on the optical path of the luminous flux reflected by the beam splitter 34c. The image pick-up section 85d is disposed on the optical path of the luminous flux transmitted through the beam splitter 34c.

It is to be noted that each of the image pick-up sections 85c, 85d is capable of receiving the luminous flux from the objective lens 32, and is constituted rotatably around the optical axis O. Concretely, the image pick-up sections 85c, 85d are rotatable along a direction along an arrow A1 in FIG. 6.

It is to be noted that each of the image pick-up sections 85c, 85d includes an image pick-up section motor (not shown), and is rotated in a direction along the arrow A1 by driving the image pick-up section motor. It is to be noted that the image pick-up section motor is connected to a control section 20. The control section 20 controls the driving of the image pick-up section motor.

Each of the image pick-up sections 85c, 85d includes a pair of image forming lenses 851, a pair of image pick-up devices 852, and CCU 853. The image forming lenses 851 and image pick-up devices 852 are arranged symmetrically centering on a middle axial center of the corresponding image pick-up sections 85c, 85d.

Each of the image pick-up devices 852 is, for example, CCD, and photographs the image formed by the corresponding image forming lens 851. The respective image pick-up devices 852 are connected to the CCU 853 to send the photographed image as an image signal to the CCU 853. The CCU 853 is connected to the projection sections 86c, 86d to sends the sent photographed image to the corresponding projection section 86c or projection section 86d.

The projection sections 86c, 86d include cases 861 in which an optical system described later is contained, and vertical rotation sections 862 which tilt the cases 861. The projection sections 86c, 86d are constituted rotatably around the optical axis O in the same manner as in the image pick-up sections 85c, 85d.

One end of the longitudinal direction of the case 861 is connected to the lens body 31 via the vertical rotation section 862 and an axial center rotation section 863. The other end of the case 861 is disposed opposite to the transmission type Fresnel lens 60b.

In FIG. 6, the vertical rotation sections 862 are constituted rotatably centering on a rotation axis (hereinafter referred to as the vertical rotation axes) along a direction crossing at right angles to a sheet surface. Therefore, the vertical rotation sections 862 rotate the case 861 along an arrow A3 in a direction along the sheet surface, and can vertically move the case. It is to be noted that the vertical rotation sections 862 include vertical rotation section motors (not shown), and are rotated by driving of the vertical rotation section motors. It is to be noted that the vertical rotation section motors are connected to the control section 20 in the same manner as in the image pick-up section motors, and the driving is controlled by the control section 20.

The axial center rotation section 863 supports the case 861 rotatably around the optical axis O. The axial center rotation section 863 is capable of rotating the case 861 in the direction along the arrow A1. It is to be noted that the axial center rotation section 863 includes the axial rotation section motor (not shown), and rotates by the driving of the axial rotation section motor. It is to be noted that the axial rotation section motor is connected to the control section 20 in the same manner as in the image pick-up section motor, and the driving is controlled by the control section 20.

Subsequently, the optical systems of the projection sections 86c, 86d will be described with reference to FIG. 7. It is to be noted that FIG. 7 shows the optical system of the projection section 86d.

Each of the projection sections 86c, 86d includes a pair of left/right monitors 864, monitor lenses 865, and optical image forming systems 866 in the case 861.

The monitors 864 are connected to the CCU 853, and display the images from the CCU 853. The monitors 864 are arranged on image forming points of the monitor lenses 865.

The monitor lenses 865 allow the luminous fluxes from the monitors 864 to be incident upon the optical image forming systems 866.

The optical image forming systems 866 form the luminous fluxes from the monitor lenses 865 into the images outside the case 861. The optical image forming systems 866 are connected to a focus adjustment motor (not shown). The position of the image forming point can be changed along the optical axis of the system by the driving of the focus adjustment motor. The focus adjustment motor is connected to the control section 20, and the driving is controlled by the control section 20 in the same manner as in the image pick-up section motor.

Subsequently, the support members 70d will be described with reference to FIG. 8. In the same manner as in the second embodiment, the support members 70d support the transmission type Fresnel lens 60b outside the lens body 31. It is to be noted that the support members 70c completely expose the region along the optical path between the transmission type Fresnel lens 60b which is the observation means and the lens body 31 to the outside of the lens body 31 in the same manner as in the first and second embodiments. In addition to the constitution similar to that of the second embodiment, each support member 70d includes an axial rotation support section 74 and a vertical rotation support section 75.

For the support member 70d, one end of the parallel section 71 is connected to the base 1 via the axial rotation support section 74 and vertical rotation support section 75.

The axial rotation support section 74 is constituted so as to be rotatable around the optical axis O (see FIG. 5). That is, the axial rotation support section 74 is capable of rotating the transmission type Fresnel lens 60b held by the support member 70d around the optical axis O. The axial rotation support section 74 includes a rotation number measurement encoder (not shown) which measures a rotary angle around the optical axis O. This rotation number measurement encoder is connected to the control section 20 to send the measured rotation angle to the control section 20.

As shown by an arrow A5, the vertical rotation support section 75 is constituted to be rotatable centering on the rotation axis along a direction crossing at right angles to the sheet surface of FIG. 8. The rotation axis is parallel to a vertical rotation axis of the rotation section 862. Therefore, the vertical rotation support section 75 rotates the transmission type Fresnel lens 60b vertically around the rotation axis. The vertical rotation support section 75 includes a rotation number measurement encoder (not shown) which measures the rotation angle around the vertical rotation axis. This rotation number measurement encoder is connected to the control section 20 to send the measured rotary angle to the control section 20.

Moreover, the stretching portion 73 of the present embodiment includes an expansion/contraction measurement encoder (not shown) which measures a change of length during the expansion/contraction. This expansion/contraction measurement encoder is connected to the control section 20 to send the measured length to the control section 20.

[Function/Effect]

The operation and effect of the operating microscope constituted as described above will hereinafter be described.

In the present embodiment, the transmission type Fresnel lens 60b is movably connected to the base 1 by the support member 70d. Therefore, first a case where the transmission type Fresnel lens 60b is not moved (before movement) will be described in the description of the function and effect of the operating microscope of the present embodiment. It is to be noted that two transmission type Fresnel lenses 60b are assumed to be arranged on the image forming point of the optical image forming system of the corresponding projection section 86c or 86d before the movement.

In the operating microscope of the present embodiment, the luminous flux from the observation portion P is transmitted through the objective lens 32 and variable power optical system 33c, and the optical path is divided by the beam splitter 34c in the same manner as in the second embodiment.

The luminous flux reflected by the beam splitter 34c is incident upon the image pick-up section 85c, and photographed by the image pick-up devices 852. The luminous flux transmitted through the beam splitter 34c is incident upon the image pick-up section 85d and photographed by the image pick-up devices 852. The photographed image is converted to the image signal capable of being displayed in the monitor 864, and sent to the corresponding monitor 864 by the CCU 853.

The monitors 864 display the observation images in response to the image signal from the CCU. The observation images are projected onto the transmission type Fresnel lens 60b via the pair of left/right monitor lenses 865 and optical image forming systems 866. The surgeon and assistant can stereoscopically observe the observation image via the transmission type Fresnel lens 60b in the same manner as in the second embodiment.

Next, a case where the transmission type Fresnel lens 60b is rotated will be described. Concretely, three cases will be described: (1) a case where the stretching portion 73 is expanded/contracted to move the transmission type Fresnel lens 60b with respect to the lens body 31 (expansion/contraction movement); (2) a case where the axial rotation support section 74 is rotated around the optical axis to move the transmission type Fresnel lens 60b with respect to the lens body 31 (rotation movement); and (3) a case where the vertical rotation support section 75 is rotated to move the transmission type Fresnel lens 60b with respect to the lens body 31 (vertical movement).

(1) Expansion/Contraction Movement

When the stretching portion 73 is expanded/contracted, the expansion/contraction measurement encoder of the stretching portion 73 measures an expanded/contracted amount of the stretching portion 73 to send the amount to the control section 20. The control section 20 issues a driving command to the focus adjustment motor of the optical image forming systems 866 in order to align the image forming point with the moved transmission type Fresnel lens 60b.

Concretely, the control section 20 calculates a rotation amount of the focus adjustment motor required for moving the image forming point by the expanded/contracted amount based on the expanded/contracted amount. Moreover, the control section 20 sends the obtained rotation amount as the driving command to the focus adjustment motor. When the focus adjustment motor rotates by the calculated rotation amount in accordance with the driving command, the optical image forming system 866 moves the image forming point to the moved transmission type Fresnel lens 60b. That is, the optical image forming system 866 moves the image forming point in synchronization with the expansion/contraction of the transmission type Fresnel lens 60b, and is capable of constantly aligning the image forming point with the transmission type Fresnel lens 60b.

Therefore, the surgeon and assistant can constantly stereoscopically observe the observation image even during the expansion/contraction of the stretching portion 73.

(2) Rotation Movement

When the axial rotation support section 74 is rotated around the optical axis O, the rotation number measurement encoder of the axial rotation support section 74 measures the rotary angle of the axial rotation support section 74 around the optical axis O to send the angle to the control section 20. The control section 20 issues the driving command to the axial rotation section motor of the axial center rotation section 863 so as to rotate the electronic stereoscopic image projection means 80c around the optical axis O so that the electronic stereoscopic image projection means 80c is capable of projecting the observation image on the transmission type Fresnel lens 60b.

Concretely, the control section 20 calculates the rotation amount of the axial rotation section motor required for rotating the case 861 by the rotary angle around the optical axis O based on the rotary angle. The control section 20 sends the obtained rotation amount as the driving command to the axial rotation section motor. The axial rotation section motor rotates by the obtained rotation amount in accordance with the driving command to rotate the case 861 around the optical axis O. By the rotation, the optical system in the case 861 moves, and the projection sections 86c, 86d move the observation image to the moved transmission type Fresnel lens 60b. In other words, by the rotation, the projection sections 86c, 86d are capable of moving the projection position of the observation image around the optical axis O.

In this manner, the electronic stereoscopic image projection means 80c moves the projection position of the observation image in synchronization with the rotation of the transmission type Fresnel lens 60b around the optical axis O, so that the observation image can constantly be projected onto the transmission type Fresnel lens 60b.

It is to be noted that the position of the transmission type Fresnel lens 60b moves by the rotation. That is, the observation position of the observer moves. Therefore, the control section 20 controls the electronic stereoscopic image projection means 80c in order to adjust the direction of the observation image projected by the projection sections 86c, 86d in accordance with the observation position.

Concretely, the control section 20 calculates the rotation amount of the image pick-up section motor required for rotating the image pick-up sections 85c, 85d by the rotary angle around the optical axis O based on the rotary angle. The control section 20 sends the obtained rotation angle as the driving command to the image pick-up section motor. The image pick-up section motor rotates by the obtained rotation amount in accordance with the driving command to rotate the image pick-up sections 85c, 85d around the optical axis O. By the rotation, the image pick-up sections 85c, 85d pick up the observation image during the observation on the observation position. In other words, the image pick-up sections 85c, 85d are capable of rotating the observation image to be photographed in synchronization with the rotation of the transmission type Fresnel lens 60b around the optical axis O. The image pick-up sections 85c, 85d project the observation image rotated in this manner onto the moved transmission type Fresnel lens 60b. Therefore, the projection sections 86c, 86d are capable of constantly matching the direction of the observation image to be projected with the observation position.

(3) Vertical Movement

When the vertical rotation support section 75 is rotated around the vertical rotation axis, the rotation number measurement encoder of the vertical rotation support section 75 measures the rotary angle around the vertical rotation axis of the vertical rotation support section 75 to send the angle to the control section 20. The control section 20 issues the driving command to the vertical rotation section motor of the vertical rotation section 862 so as to rotate the electronic stereoscopic image projection means 80c around the vertical rotation axis so that the electronic stereoscopic image projection means 80c is capable of projecting the observation image on the transmission type Fresnel lens 60b.

Concretely, the control section 20 calculates the rotation amount of the vertical rotation section motor required for rotating the case 861 by the rotary angle around the vertical rotation axis based on the rotary angle. The control section 20 sends the obtained rotation amount as the driving command to the vertical rotation section motor. The vertical rotation section motor rotates by the obtained rotation amount in accordance with the driving command to rotate the case 861 around the vertical rotation axis. By the rotation, the optical system in the case 861 moves, and the projection sections 86c, 86d move the observation image to the moved transmission type Fresnel lens 60b. In other words, the projection sections 86c, 86d are capable of moving the projection position of the observation image in the vertical direction by the rotation.

In this manner, the electronic stereoscopic image projection means 80c moves the projection position of the observation image in synchronization with the rotation of the transmission type Fresnel lens 60b around the optical axis O, so that the observation image can constantly be projected onto the transmission type Fresnel lens 60b.

Moreover, the surgeon and assistant can use the space exposed to the outside between the lens body 31 and the transmission type Fresnel lens 60b which is the main and sub-observation means to directly view the operation part in the same manner as in the first and second embodiments. In this manner, by the operating microscope of the present embodiment, in addition to the observation of the observation portion via the objective optical system, the observation by the direct viewing can easily be carried out in the same manner as in the first and second embodiments.

Moreover, for the operating microscope of the present invention, since the transmission type Fresnel lens 60b is used as the main and sub-observation means, the main and sub-finders satisfactory in operability can be provided in the same manner as in the second embodiment. Furthermore, the surgeon's and assistant's standing positions during the surgical operation are freely selected, and the surgical operation can easily be carried out in the same manner as in the second embodiment. Additionally, in the operating microscope of the present embodiment, the transmission type Fresnel lens 60b which is the image forming means forms the observation image by the luminous flux from the electronic stereoscopic image projection means 80c. Therefore, the observation image can be formed using the electronic stereoscopic image projection means 80c without using the image display such as the monitor that narrows an operation space. Therefore, the operating microscope of the present embodiment can present a comparatively broad operation space to the surgeon.

Furthermore, since the support member 70d of the present embodiment can expand/contract along the longitudinal direction of the parallel section 71 in the same manner as in the second embodiment, the interval between the lens body 31 and the transmission type Fresnel lens 60b can be set to such an extent that the surgeon and assistant can directly view the observation portion P.

Additionally, the electronic stereoscopic image projection means 80c of the present embodiment is capable of constantly projecting the observation image on the transmission type Fresnel lens 60b in synchronization with the rotation of the transmission type Fresnel lens 60b around the optical axis O, and is capable of constantly match the direction of the observation image to be projected with the observation position as described above in (2) Rotation Movement. Therefore, in the same manner as in the second embodiment, the operating microscope of the present embodiment is capable of adjusting the direction of the observation image to alleviate the observer's fatigue, even when the transmission type Fresnel lens 60b rotates around the optical axis O.

Moreover, as described above in (3) Vertical Movement, the electronic stereoscopic image projection means 80c of the present embodiment is capable of vertically moving the projection position of the observation image in synchronization with the rotation of the vertical rotation support section 75 to constantly project the observation image onto the transmission type Fresnel lens 60b. Therefore, the transmission type Fresnel lens 60b can be moved in the vertical direction in a state in which the operation part can be observed in the operating microscope of the present embodiment. Therefore, for the operating microscope of the present embodiment, the surgeon's and assistant's observing positions and standing positions during the surgical operation are freely selected, and the surgical operation can easily be carried out.

It is to be noted that in the present embodiment, the transmission type Fresnel lens 60b may also be constituted to be movable not only in the vertical direction but also in any three-dimensional direction. In this case, the projection sections 86c, 86d are constituted to be capable of three-dimensionally moving the projection position of the observation image. Moreover, the control section 20 controls the projection sections 86c, 86d so as to move the projection position of the observation image in synchronization with the movement of the transmission type Fresnel lens 60b. Accordingly, by the operating microscope of the present embodiment, the surgeon's and assistant's observing positions and standing positions during the surgical operation can freely be selected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A stereoscopic microscope comprising:
an optical objective lens for observation, transmitting luminous fluxes from objects;
an optical splitter to divide the luminous flux transmitted through the optical objective lens into at least two;
a lens body which holds the optical objective lens and the optical splitter;
an image forming device which is disposed on at least one optical path of the luminous fluxes divided by the optical splitter to form an observation image by the luminous fluxes; and
a support member for the image forming device which stride over at least a part of the optical path exposed to the outside of the lens body.

2. The stereoscopic microscope according to claim 1, wherein the optical splitter includes:
a beam splitter which divides one of the luminous fluxes from the optical objective lens; and
an optical image forming lens which forms an image by the luminous flux divided by the beam splitter, and
the image forming device is disposed in an image forming position of the optical image forming lens.

3. The stereoscopic microscope comprising:
an optical objective lens for observation, transmitting luminous fluxes from objects;
a lens body which holds the optical objective lens;
an image pick-up device which is disposed in the lens body to pick up the image of the luminous flux transmitted through the optical objective lens;
an electronic image projection device which projects the image photographed by the image pick-up device;
an image forming device which is disposed on the optical path of the luminous flux from the electronic image projection device to form an observation image by the luminous fluxes; and
a support member which supports the image forming device in such a manner that at least a part of the optical path of the luminous flux to the image forming device from the electronic image projection device exposed to the outside of the lens body.

4. The stereoscopic microscope according to claim 1, wherein the image forming device is a transparent type Fresnel lens.

5. The stereoscopic microscope according to claim 1, wherein the image forming device is a diffusion plate.

6. The stereoscopic microscope according to claim 1, which comprises a main body connected with the image forming device, a distance via which the image forming device is disposed opposite to the stereoscopic microscope main body being variable.

7. The stereoscopic microscope according to claim 6, wherein the optical splitter is constituted to divide a luminous flux from the optical objective lens and to form an image by the divided luminous fluxes, and an image forming distance is changed by the optical splitter in accordance with the distance via which the image forming device is disposed opposed to the stereoscopic microscope main body.

8. The stereoscopic microscope according to claim 1, which comprises a main body for connecting the image forming device, an angle via which the image forming device is disposed opposite to the stereoscopic microscope main body being variable.

9. A stereoscopic microscope comprising:
an optical objective system for observation, transmitting luminous fluxes from objects;
a lens body which holds the optical objective system;
optical dividing means which is disposed in the lens body to divide the luminous flux transmitted through the optical objective system into at least two;
image forming means which is disposed on at least one optical path of the luminous fluxes divided by the optical dividing means to form an observation image by the luminous fluxes; and
support means for the image forming means, which strides over at least a part of the optical path of the luminous flux to the image forming means from the optical dividing means to the outside of the lens body.

10. The stereoscopic microscope according to claim 9, wherein the optical dividing means includes:
a beam splitter which divides the luminous flux from the optical objective system; and
an optical image forming system which forms an image by the luminous fluxes divided by the beam splitter, and
the image forming means is disposed in an image forming position of the optical image forming system.

11. A stereoscopic microscope comprising:
an optical objective lens for observation, transmitting luminous fluxes from objects;
a lens body which holds the optical objective lens;
image pick-up means for picking up the image of the luminous flux transmitted through the optical objective system;
electronic image projection means for projecting the image photographed by the image pick-up means;
an image forming device which is disposed on at least one optical path of the luminous fluxes from the electronic image projection means to form an observation image by the luminous fluxes; and
support means for the image forming means in such a manner that at least a part of the optical path of the luminous flux to the image forming means from the electronic image projection means is exposed to the outside of the lens body.

12. The stereoscopic microscope according to claim 9, wherein the image forming means is a transparent type Fresnel lens.

13. The stereoscopic microscope according to claim 9, wherein the image forming means is a diffusion plate.

14. The stereoscopic microscope according to claim 9, which comprises a main body for connecting the image forming means, a distance via which the image forming means is disposed opposite to the stereoscopic microscope main body being variable.

15. The stereoscopic microscope according to claim 14, wherein the optical dividing means is constituted to divide a luminous flux from the optical objective system and to form an image by the divided luminous fluxes, and an image forming distance is changed by the optical dividing means in accordance with the distance via which the image forming means is disposed opposite to the stereoscopic microscope main body.

16. The stereoscopic microscope according to claim 9, which comprises a main body for connecting the image forming means, an angle via which the image forming means is disposed opposite to the stereoscopic microscope main body being variable.

17. An observation mechanism for use in a stereoscopic microscope, comprising:
a projection device disposed on an optical observation system of the stereoscopic microscope; and
an image forming device which is disposed opposite to the projection device through the outside space.

18. The observation mechanism for use in the stereoscopic microscope according to claim 17, wherein the projection device is an electronic image projection device.

19. The observation mechanism for use in the stereoscopic microscope according to claim 17, wherein the image forming device is a transparent type Fresnel lens.

20. The observation mechanism for use in the stereoscopic microscope according to claim 17, wherein the image forming device is a diffusion plate.

21. The observation mechanism for use in the stereoscopic microscope according to claim 17, wherein the image forming device is constituted to be connectable to the stereoscopic microscope main body, and a distance via which the image forming device is disposed opposite to the stereoscopic microscope main body is variable.

22. The observation mechanism for use in the stereoscopic microscope according to claim 21, wherein an image forming distance is changed by the projection device in accordance with the distance via which the image forming device is disposed opposite to the stereoscopic microscope main body.

23. The observation mechanism for use in the stereoscopic microscope according to claim 17, wherein the image forming device is constituted to be connectable to the stereoscopic microscope main body, and an angle via which the image forming device is disposed opposite to a stereoscopic microscope main body is variable.
